(19) United States
(12) Patent Application Publication
(10) Pub. No.: US 2012/0257218 A1
(43) Pub. Date: Oct. 11, 2012

(54) METHOD FOR LONGITUDINALLY STABILIZING AN OPTICAL CAVITY

(75) Inventors: Olivier Pinel, Paris (FR); Benoît Chalopin, Paris (FR); Nicolas Treps, Paris (FR)

(73) Assignees: UNIVERSITE PIERRE ET MARIE CURIE (PARIS 6), Paris (FR); ECOLE NORMALE SUPERIEURE, Paris (FR); CENTRE NATIONAL DE LA RECHERCHE SCIENTIFIQUE, Paris (FR)

(21) Appl. No.: 13/497,487

(22) PCT Filed: Sep. 22, 2010
(86) PCT No.: PCT/EP10/05795

§ 371 Date: Jun. 4, 2012

(30) Foreign Application Priority Data
Sep. 23, 2009 (FR) 0904537

(51) Int. Cl. G01B 11/14

(52) U.S. Cl. 356/614

(57) ABSTRACT

A method of stabilizing the distance (L) between two mirrors (3, 4) of an optical cavity (2). The method includes the steps of injecting into the cavity an incident light beam in the form of a comb of frequencies; observing the spectrum of the light emitted or reflected by the cavity by using a photodiode having at least two sensitive zones that are arranged relative to the emitted or reflected light in such a manner that when the spectrum is centered, the two sensitive zones of the photodiode are illuminated equally; and modifying the distance between the mirrors of the cavity so as to cancel any offset of the spectrum relative to a situation in which the spectrum is centered.

The invention relates to a method of stabilizing the length of an optical cavity of the Fabry-Perot type.

### TECHNOLOGICAL BACKGROUND

Such an optical cavity comprises at least two facing mirrors, at least one of which is associated with an actuator for moving it (the actuator generally being of the piezoelectric type) for the purpose of adjusting the distance between the mirrors so that the distance corresponds to a multiple of the wavelength of the light source injected into the cavity.

It is found that this distance may vary under the effect of various factors that are not under control (mechanical vibration, thermal expansion, . . . ), and that it is important to be able to move one of the mirrors in order to return the distance between the mirrors to the desired value.

For this purpose, a first known method is the so-called “PDH” method (named for Pound, Dreyer, Hall, the names of its inventors) that consists in modulating the phase of the incident beam and in mixing the modulated signal with the beam from the cavity so as to create an error signal representative of a difference between the frequency of the cavity (directly linked to the distance between the mirrors) and the frequency of the beam. The movable mirror is servo-controlled so that the error signal is canceled. That method is described in: Dreyer, Hall, Kowalski, Hough, Ford, Munley, Ward, Laser phase and frequency stabilization using an optical resonator, Appl. Phys. B: Laser Opt., 1983, Volume 31, Number 2, pp. 97-105.

Nevertheless, such a method is not simple to use with pulse lasers since the modulating material that is generally used deforms the pulses. Furthermore, such a material is expensive.

Another known method is the “Hänsch-Couillaud” method that consists in polarizing the incident beam to generate interference in the cavity. The interference is measured by a detector delivering a signal that is used to servo-control the position of the movable mirror. That method of adjustment is extremely sensitive and poorly compatible with industrial use. The method is described in Hänsch, Couillaud, Laser frequency stabilization by polarization spectroscopy of a reflecting reference cavity, Opt. Commun., 1980, Volume 35, Issue 3, pp. 441-444.

Another known method is the “tilt-locking” method that consists in causing a small deviation in the incident beam to excite the cavity in two transverse modes that give rise to interference. The interference is measured by a two-zone detector, and the signal from the detector is used for servo-controlling the position of the movable mirror. That method is described in Shaddock, Gray, McClelland, Frequency locking a laser to an optical cavity by use of spatial mode interference, Opt. Lett. 1999, Vol. 24, pp. 1499-1501.

Those methods can be implemented equally well for passive cavity lasers and for active cavity lasers.

Finally, proposals have been made to use the spectrum of the beam leaving the cavity of an optical parametric oscillator. That spectrum depends on the group velocity dispersion inside the cavity as caused by the presence of the non-linear crystal inside the cavity. For that purpose, a portion of the emitted radiation is taken and directed to a diffraction grating. The diffracted beam is then directed to a detector of the position-sensitive detector (PSD) type, and the signal from the detector is used to servo-control the position of the movable mirror of the cavity. In particular, the servo-control is adjusted so that the desired distance corresponds to a situation in which the beam touches the detector at its center.

That method is described in Butterworth, Girard, Hanna, A simple technique to achieve cavity-length stabilization in a synchronously pumped optical parametric oscillator, Optics Communications, Elsevier, 1996, Vol. 123(4-6), pp. 577-582. That method is simple and inexpensive, but it can be applied only to active cavity parametric oscillators.

Finally, in a field that is remote from stabilizing optical cavities, suggestions are made in the article by Gohle, Stein, Schliesser, Hänsch, Frequency comb Vernier spectroscopy for broadband, high-resolution, high-sensitivity absorption and dispersion spectra, Physical Review Letters, APS, 2007, Vol. 99(26), pp. 263902, to perform spectroscopy by injecting a femtosecond frequency comb into a Fabry-Perot resonator containing the sample for analysis. The length of the cavity is selected so that each m^{th} mode of the comb is resonant with the n^{th} mode of the cavity. This produces a vernier effect having the ratio m/n.

### OBJECT OF THE INVENTION

An object of the invention is to propose a method of adjusting the distance between the mirrors of an optical cavity that is very simple and that can be implemented at low cost.

### BRIEF SUMMARY OF THE INVENTION

In order to achieve this object, the invention provides a method of stabilizing the distance between two mirrors of an optical cavity, the method comprising the steps of:
injecting into the cavity an incident light beam in the form of a comb of frequencies;
observing the spectrum of the light emitted or reflected by the cavity by using a photodiode having at least two sensitive zones that are arranged relative to the emitted or reflected light in such a manner that when the spectrum is centered, the two sensitive zones of the photodiode are illuminated equally; and
modifying the distance between the mirrors of the cavity so as to cancel any offset of said spectrum relative to a situation in which said spectrum is centered.

In order for the cavity to be resonant with the incident beam, it is necessary for its length to be equal to the distance between two successive pulses. Nevertheless, if the pulses of the incident beam are sufficiently long (typically more than ten times the central wavelength), then resonance is also obtained for a cavity length that differs from the length corresponding to the central resonance by only a few wavelengths. If the length of the cavity corresponds to one of the lengths that gives rise to such resonance, then the spectrum of the light emitted or reflected by the optical cavity is substantially centered, without being offset.

If the length of the cavity is not exactly equal to one of the lengths giving rise to resonance, then the emitted or reflected light presents a spectrum that is offset, which appears to be due to a vernier effect between the frequencies of the comb of the injected beam and the resonant frequencies of the cavity. It then suffices to correct the distance between the mirrors in the direction that is appropriate for canceling the offset. This enables the distance between the mirrors to be servo-controlled on a value that corresponds to a centered spectrum.

Thus, unlike the photodiode in the article Spectroscopy for broadband, high-resolution, high-sensitivity absorption and dispersion spectra, Physical Review Letters, that is used solely for performing spectroscopy of a sample, the photodiode having at least two sensitive zones is used in this example to servo-control the distance between the mirrors in order to stabilize the optical cavity.

In practice, the emitted or reflected light in this example is diffracted by using a diffraction grating, with the diffracted beam being picked up by the quadrant diode arranged relative to the diffracted beam in such a manner that when the spectrum is centered, the two sensitive zones of the photodiode are illuminated equally.

### BRIEF DESCRIPTION OF THE FIGURES

The invention can be better understood in the light of the following detailed description of a particular embodiment of the invention, given with reference to the figures of the accompanying drawing, in which:

FIG. 1 is a block diagram showing how the method of the invention is implemented; and

FIG. 2 is a diagrammatic view of an asymmetrical spectrum that results from a non-matched cavity length.

### DETAILED DESCRIPTION OF AN EMBODIMENT OF THE INVENTION

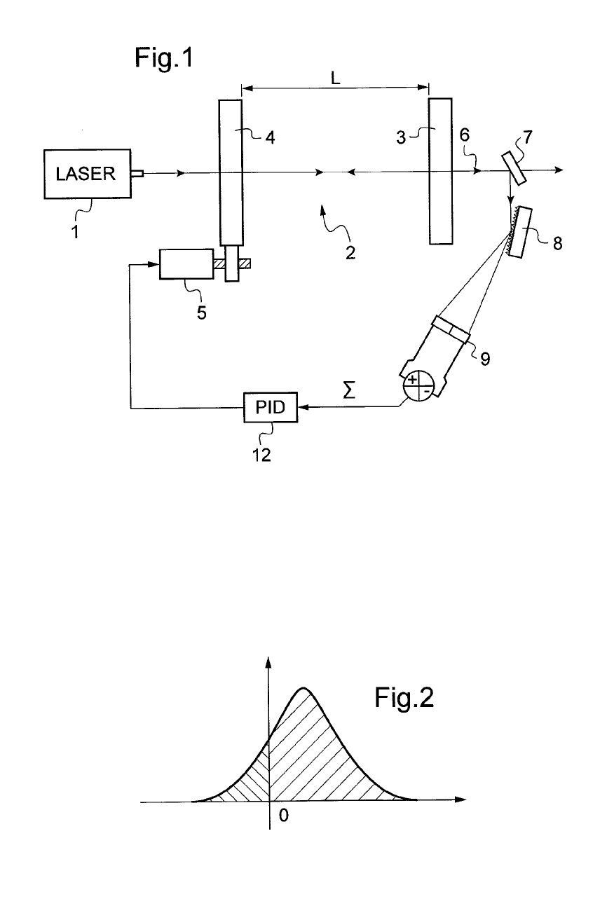

With reference to FIG. 1, the method is implemented in this example in application to a pulse laser. The laser 1 delivers an incident beam in the form of pulses, each having a duration of 100 femtoseconds (fs), centered on a wavelength of 800 nanometers (nm), at a repetition rate of 75 megahertz (MHz), thus forming a comb of frequencies. The beam is sent to a Fabry-Perot cavity 2 comprising a stationary mirror 3 and a movable mirror 4, which mirror may be moved towards or away from the stationary mirror by means of an actuator 5. In this example, the distance L between the mirrors is substantially 4 meters (m). The beam that has penetrated into the cavity is subjected to a multitude of reflections on the two facing mirrors. The cavity 2 emits an outlet beam 6 having characteristics that can be analyzed.

According to the invention, a portion of the emitted beam 6 is taken using a separator 7 for the purpose of lighting a diffraction grating 8. The diffracted beam is received by a quadrant photodiode 9 that has two sensitive zones generating respective electrical signals 10 and 11 that are proportional to the intensity of the radiation received by the corresponding zone. The difference is taken between the signals in order to define an error signal that forms the input to a corrector 12, specifically a proportional integral differential (PID) corrector in this example, having an output that forms a signal for controlling the actuator 5. Thus, the distance L is servo-controlled to a value L* at which the error signal is zero, which corresponds to a centered spectrum striking the two sensitive zones of the photodiode 9 in balanced manner.

FIG. 2 shows the spectrum of a beam that is emitted when the distance L is different from the resonant distance L*. The spectrum is offset (to the right in this example), thus making it asymmetrical and giving rise to a non-zero error signal. The above-described stabilization method enables the distance L within the cavity to be returned to the value L* for which the spectrum is symmetrical (ignoring lag errors, well known in servo-control systems).

The distance L* as maintained in this way is in practice equal to the distance that corresponds to the fundamental resonance Lr plus a few wavelengths. At such a distance, the error signal changes sign whenever the distance L crosses the value L*, thereby enabling the movement direction of the movable mirror to be changed when the distance L crosses the value L*. It should be observed that such a change of sign is normally not observed around the fundamental resonance distance Lr. Nevertheless, the offset is minimal and entirely acceptable (a few micrometers, to be compared with a distance of several meters).

The method of the invention is particularly simple to implement with means that are inexpensive.

Naturally, the invention is not limited to the above description, but covers any variant coming within the ambit defined by the claims.

In particular, although the stabilization method of the invention is illustrated above in an application to a passive optical cavity, the method is naturally applicable to optical cavities that are active, e.g. including a non-linear crystal, or to cavities that include a sample for analysis by spectroscopy.

Although the corrector used in this example is a PID corrector, it would naturally be possible to use other correctors, either correctors that are more simple (a mere proportional corrector), or else more complex, e.g. an H-infinity (H∞) corrector. In general, the error signal is generated by observing asymmetry in the light spectrum emitted by the cavity, as described herein by using a quadrant photodiode, or by using any other device that is sensitive to such asymmetry.

Although it is stated that the spectrum offset is observed by using a quadrant photodiode, the invention is not limited to using such a photodiode, and it is possible to use any means capable of generating a signal that is representative of a spectrum offset.

Finally, although it is stated that the invention is applied to the spectrum of the light emitted by the cavity, the method could equally well be applied to monitoring the spectrum of the light reflected by the cavity towards the light source.

What is claimed is:

1. A method of stabilizing the distance (L) between two mirrors (3, 4) of an optical cavity (2), the method comprising the steps of:
injecting into the cavity an incident light beam in the form of a comb of frequencies;
observing the spectrum of the light emitted or reflected by the cavity by using a photodiode having at least two sensitive zones that are arranged relative to the emitted or reflected light in such a manner that when the spectrum is centered, the two sensitive zones of the photodiode are illuminated equally; and
modifying the distance between the mirrors of the cavity so as to cancel any offset of said spectrum relative to a situation in which said spectrum is centered.

2. A method according to claim 1, wherein an error signal (8) is generated that is representative of the spectral offset of the spectrum by taking the difference between signals (10, 11) generated respectively by the two sensitive zones of the photodiode, the error signal being used to control an actuator for moving one of the mirrors of the cavity.
